(19) United States
(12) Patent Application Publication
(10) Pub. No.: US 2024/0232053 A1
(43) Pub. Date: Jul. 11, 2024

(54) Generation of Hardware Description Language (HDL) Code Using Machine Learning

(71) Applicant: Primis, Inc., Los Gatos, CA (US)

(72) Inventor: Valerio Tenace, Torino (IT)

(21) Appl. No.: 18/408,555

(22) Filed: Jan. 9, 2024

Related U.S. Application Data
(60) Provisional application No. 63/479,345, filed on Jan. 10, 2023.

(51) Int. Cl. G06F 11/36; G06N 3/0455

(52) U.S. Cl. CPC G06F 11/3664; G06N 3/0455

(57) ABSTRACT

Technology is described for generating HDL code using machine learning. The method can include receiving a request which includes a natural-language description for a high-level representation of computer hardware. Another operation may be generating code which includes HDL code for a module, using a deep neural network. The request may be used as input to the deep neural network. A testbench for the code may be generated using the deep neural network. The features of the code and the request may be input into the deep neural network. A further operation may be executing a functional simulation of the code using the testbench. The code for the module may then be sent to be presented through an interface to a user when the function simulation passes.

### PRIORITY CLAIM

This patent application claims priority to U.S. Provisional Patent Application Ser. No. 63/479,345 filed on Jan. 10, 2023 entitled “GENERATION OF HARDWARE DESCRIPTION LANGUAGE (HDL) CODE USING MACHINE LEARNING”.

### BACKGROUND

Linters are specialized computer programs that assist developers in enhancing source code quality. Typically, they operate in real-time as developers input source code, offering guidance through warnings and error messages. These tools are adept at detecting a range of issues such as inconsistencies, typographical errors; programming errors, potential bugs, vulnerabilities, and stylistic errors, all before the source code is compiled. Linters are available for numerous programming languages, and examples of linters include ESLint for JavaScript, Pylint for Python, and Clang-Tidy for C/C++. Since their inception in the late 1980s, linters have significantly boosted developer productivity. Needless to say, with ever-changing technologies, linters have evolved as well. In 1996, Microsoft released their first linter for the Visual Basic language, called IntelliSense. The idea was not only to provide users with practical integration for a static code analysis, but Microsoft's linter was a way to provide developers with more advanced (for that time) real-time code suggestions, e.g., autocompletion of API calls or presenting the user with a drop-down list from which to select the already declared variables.

Thanks to the progress of Artificial Intelligence (AI), in the last few years, the concept behind linters has further evolved into broader-spectrum “code companions”, namely, smart assistants that not only advise the user about code quality but can also suggest entire code routines. An example of a code companion is GitHub Copilot, which was released at the end of 2021. Being powered by OpenAI Codex, Copilot serves as an effective code completion tool for a variety of programming languages, and it can also be used to optimize code to improve their performance.

### BRIEF DESCRIPTION OF THE DRAWINGS

FIG. 1 is a block diagram illustrating an example of a system-level overview of the present framework and technology.

FIG. 2 is an example of a flowchart illustrating an input request and an output response containing HDL code for the workflow or processes.

FIG. 3 is a flowchart illustrating an example of an input module definition, which may result in the generation of the testbench and a diagnostic.

FIG. 4 is a block diagram illustrating an example of a training data set containing synthesizable Verilog source code.

FIG. 5 is an example flowchart of a method for generating HDL code using machine learning.

FIG. 6 is a block diagram of a service provider environment according to an example of the present technology.

FIG. 7 is a block diagram that provides an example illustration of a computing device that may be employed in the present technology.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

This technology may provide an AI-powered pair programmer or code companion for hardware description languages (HDLs). The framework of this technology can provide a powerful autocomplete function for HDL code, through which the user can generate entire HDL code modules or code entities simply by specifying a descriptive name or a descriptive set of text terms. In addition, this framework may enforce code robustness for the user's codebase through an AI-powered automated functional verification flow.

The code referred to here may be HDL code or similar types of code for computer hardware specification languages or hardware modeling languages that may be hardware synthesizable. The terms modules and entities, as used in this description, may represent any number of lines of code that represent a portion of hardware functionality, a hardware function, a grouping of hardware functionality, architectures, designs or generic logic fabric (e.g., that can be applied as a core or logic using Soft IP (Intellectual Property)). The term module may also correspond with a specific hardware function that uses the reserved word “module” in the HDL language with hardware inputs and outputs but this is only one option.

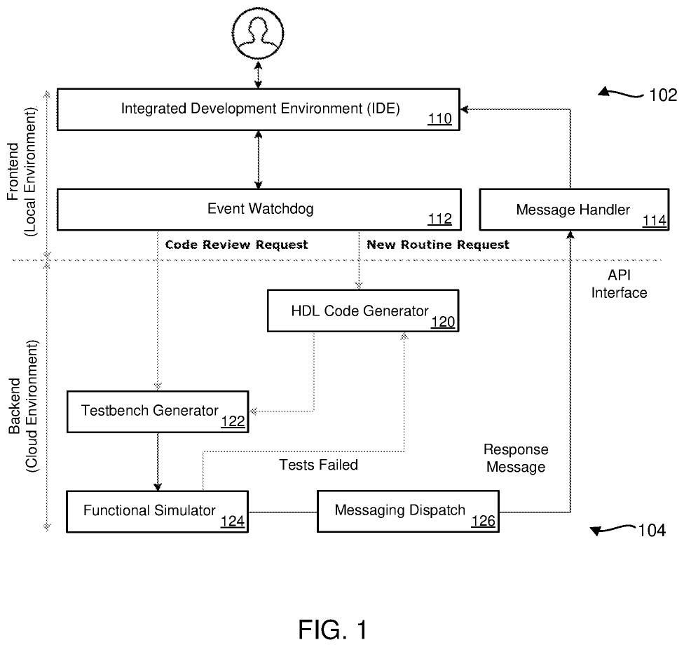

FIG. 1 depicts an example system-level overview of a framework for this technology. The framework may have two or more main components: (1) a backend 104, which may be where the custom processes and the AI model are deployed; and (2) a frontend 102, which may serve as a user interface for the backend.

The frontend 102 may use a dedicated plugin or extension for extensible IDEs (Integrated Development Environments 110) that offer this possibility. Alternatively, the frontend 102 may be a proprietary graphical or text user interface and process. The frontend 102 may be a gateway to the framework's remote components, and the front end 102 may further include an event watchdog (EW) 112, and a message handler (MH) 114. The front end 102 may be in charge of sending requests to the API (application programming interface) or API interface, as denoted by a dotted line in FIG. 1, whereas the backend 104 may handle responses and send the output code or error messages to be displayed to the end user. The message handler 114 may vary according to the level of integration a given IDE has to offer.

The event watchdog 112 may play a role in coordinating communications with the backend 104. The event watchdog 112 may be a highly available (e.g., always running when an IDE is executing) process that continuously checks the status of the active files of the user (e.g., files that belong to an open project for instance). User inputs may activate the event watchdog 112, and the event watchdog 112 may trigger one or more events, such as the following two events:
New Routine Request (NRR): This event may be triggered whenever the user starts typing the beginning of a new module instance in their design. This event may also be triggered when a comment is entered, i.e., by means of the /* and */ code tags.
Code Review Request (CRR): This event may be triggered every time the user modifies and/or saves a given module in the active environment. Furthermore, the event may also be triggered whenever the user includes a new module definition in the active project, i.e., via a library import or copy and paste.
   Both the NRR and CRR events, including how they are handled by the backend 104, are described in more detail below.

The backend 104 may include a remotely accessible API, which may be available as a Software-as-a-Service product. For example, a RESTful API may be used to access services in a public or private cloud. The backend 104 may include two main workflows, each of which may be triggered by the event watchdog events already discussed earlier, i.e., the NRR and CRR. Both scenarios are described:

NRR Workflow. This workflow and its associated processes may receive the active line buffer edited by the user. The line buffer may be forwarded to the HDL code generator 120 that may automatically generate and/or complete the module definition. This module definition may then be passed through the testbench generator 122. During this stage, an ad hoc or HDL module focused testbench may be devised by the same AI model used for code autocompletion (e.g., a copy of the AI model or one model trained for two generation purposes may be used). The input to the AI model that may provide the testbench may be the module code definition generated by the HDL code generator 120. The testbench itself may be testbench HDL code that is used to test the HDL module that was generated by the HDL code generator 120. Thus, the original HDL module that was generated may be considered the unit under test. The testbench module or code may contain statements to apply inputs (i.e., test vectors) to the unit under test and to check that the correct outputs are produced.

A functional simulation can be carried out on a functional simulator 124 using the testbench module obtained in the previous step, and the testbench module can be applied to the HDL code or module definition generated by the HDL Code Generator 120 as the unit under test.

If one or more tests for the module definition and code fail, the HDL code generator is invoked again, using the same input terms from the user, in order to generate a different code module or block. The process of HDL module and testbench generation may repeat until a defined amount of the testbench tests are passed (e.g., 100%, 95%, 85%, etc.). Once the tests are passed, the response message, which may include the body of the inferred or generated module definition, may be sent by the message dispatch 126 to the frontend 102, encapsulated in an API response. The message dispatch 126 may be separate from the function simulator 124 or combined with the function simulator 124.

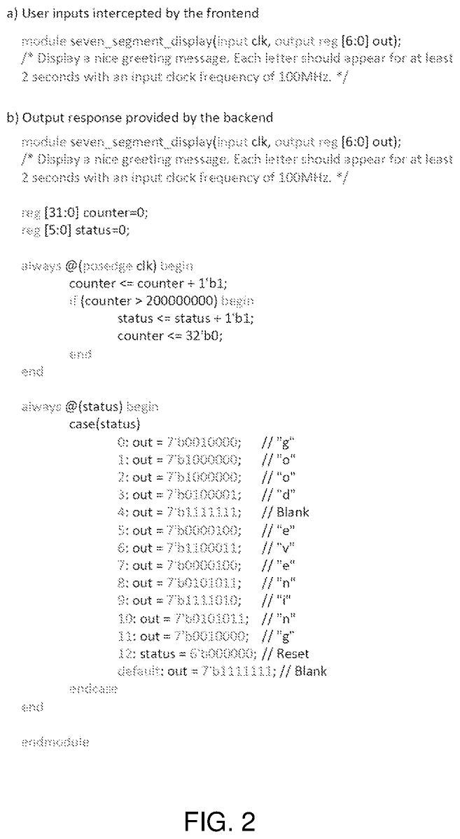

FIG. 2 illustrates an example input request for this workflow (See section “a)” in FIG. 2), and its corresponding response (See section “b)” in FIG. 2). The workflow and its processes may receive or contain a module definition with a descriptive name, i.e., seven_segment_display, which is leveraged by the AI model in the HDL code generator (120 in FIG. 1) for generating the corresponding code of the module. At the same time, the input set of terms is interpreted by the AI model to generate or infer the module definition the user wants to see. The result is achieved in a single call to the AI model, which has been specifically trained to perform Verilog code autocompletion tasks. The module definition or descriptive name may be a natural language description of the desired HDL module.

CRR Workflow. As the frontend (102 in FIG. 1) keeps track of new pieces of code introduced by the user (e.g., stores the new pieces of code in files or a database), this workflow and its processes may check the robustness of any part of active codebase or the entire active codebase. The CRR event may receive as input one or more complete user-defined modules (at least one module per request) to check one or more already generated modules. The built-in AI model may leverage the input module name or the entire HDL module to autogenerate a useful and syntactically correct testbench using the test bench generator (122 in FIG. 1). The testbench generator may then launch or execute using a Verilog compliant simulation environment (there are several possible choices for this, both commercial and open-source) using the functional simulator (124 in FIG. 1), which is setup to write diagnostic information (warning and error messages, for instance) in temporary files which are subsequently processed at the end of the simulation. The purpose of this last step is to create a list of issues identified within the input code provided. The diagnostic may be parsed from the temporary file, wrapped in an API response, and finally displayed to the end user via the frontend/IDE.

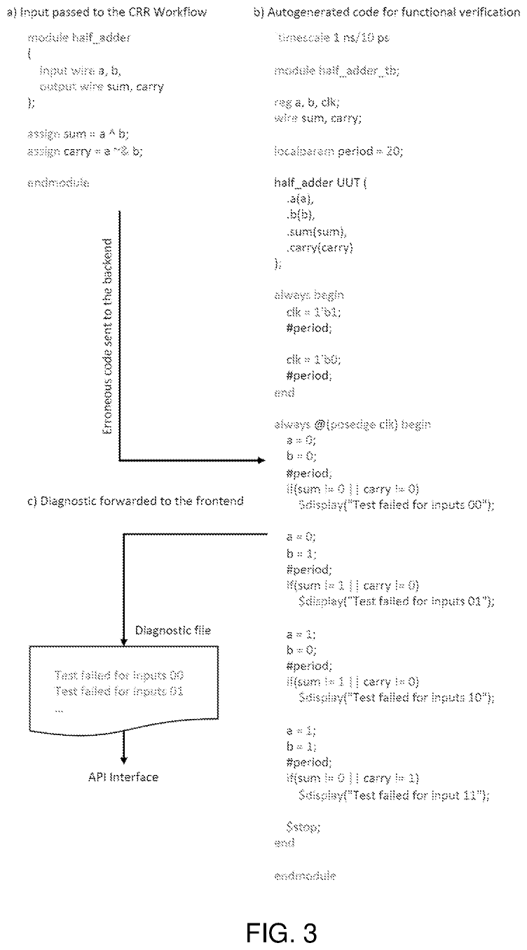

In one configuration, if the diagnostic fails in defined ways as defined by assertion statements in the HDL testbench, the diagnostic and the defined module may not be displayed to the end user. Instead this defined module may be considered unusable. For example, if the diagnostic fails in ways defined by the testbench, then the failures may be because of unexpected results were obtained at simulation time. In FIG. 3, a testbench is illustrated with some $display statements enclosed within if statements. Those $display statements are used for “assertions”, which are not part of the Verilog language syntax. While assertions do not exist in Verilog, assertions do exist in the SystemVerilog language syntax. Besides testbench failures, there may be diagnostic failures where other problems prevent the system from completely running the simulation, such as syntax or compilation errors. These types of errors are quite common when code is generated by LLMs (large langue models).

At this point, a test failure message may be sent to the HDL code generator and the AI in the HDL code generator 120 may be re-executed with the same initial input set of terms or request. This may re-generate a new module that is different than the previous module and then trigger a testbench to be created for the new module. Hyperparameters, like temperature, nucleus sampling, or max token size, may also be used and adjusted by the user to vary the module output, if desired, in order to influence the amount of difference that may occur in each re-generation of the HDL module. This process might occur several times before a logically correct defined module is provided to the end user.

FIG. 3 illustrates an example input module definition depicted by section “a)” in FIG. 3, which leads the AI model to produce the testbench reported in section “b)” of FIG. 3. The simulation environment then produces the diagnostic reported in section “c)” of FIG. 3. FIG. 3 is an example workflow representation depicting inputs and outputs for the CRR task. The example input code is provided with a typo on the penultimate line (i.e., second to last line of the module “half_adder” where the carry operator is a bitwise NAND instead of AND) in section “(a)”. An autogenerated testbench is shown in section “(b)”. Intermediate diagnostic info can be later used by the frontend to craft a specific message for the end user as in section “(c)”.

In one example, the AI model may employ a GPT-like (Generative Pre-trained Transformer-like) deep neural network, i.e., an autoregressive language model specifically designed to generate sequences of words, code or other data, starting from a source input. The model architecture may include HDL code autogeneration tasks. In an example implementation, the model architecture may be trained using a custom training routine consisting of two different phases: (1) a pre-training phase executed using a language data set (e.g., the Pile dataset), which is an English text corpus designed for training large-scale language models; and (2) a fine-tuning phase that leverages a dataset of synthesizable HDL code chunks (or blocks). The data set of HDL code may be Verilog code or another HDL language.

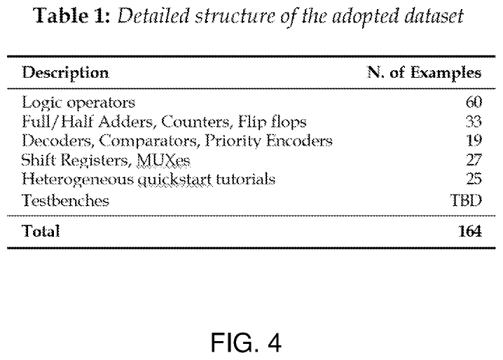

An example structure of a training data set with synthesizable Verilog source code may be detailed in FIG. 4, which lists a number of training examples provided in various categories of HDL source code. The fine-tuning phase may last 50 epochs, which allows the framework to achieve reasonable generalization capabilities, i.e., inferred code chunks that are different from those contained in the training dataset illustrated by FIG. 4. However, any size of a Verilog source code training set may be used to train the AI.

To summarize, this technology provides a pair programmer for HDL languages. The testbench autogeneration may enable a user to receive those modules generated by the AI that have verifiable testbench output. Furthermore, this technology may have autocomplete capabilities that can be used with any other hardware design or modeling languages.

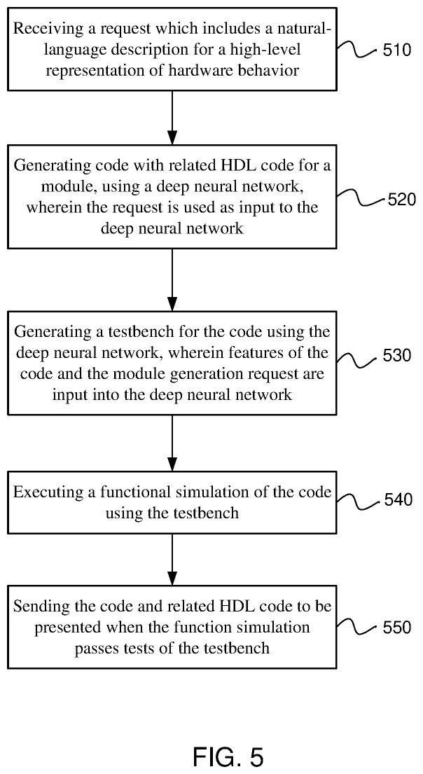

FIG. 5 is a flowchart illustrating a method for generating HDL code using machine learning. The method may include receiving a request which includes a natural-language description for a high-level representation of computer hardware and/or computer hardware behavior, as in block 510. Natural language descriptions of computer hardware behavior may include functions the computer hardware is desired to do, functions of the logic in the computer hardware, or ways in which the computer hardware may be structured for desired functionality.

Another operation may be generating code with HDL code for a module, using a deep neural network, as in block 520. The deep neural network may have been trained on a data set of synthesizable HDL code chunks. In addition, the deep neural network may be a language model. For example, the deep neural network neural network may be a transformer, encoder-decoder transformer, a text-to-text transformer or a generative adversarial network (GAN). The request may be used as input to the deep neural network to obtain the HDL code. Some features of the HDL code may include at least one of: a number of inputs, a number of outputs, functional keywords, hardware keywords, or memory keywords. The HDL code may be in Verilog or VHSIC Hardware Description Language (VHDL) or another hardware specification language or hardware modeling language. The HDL code may be 1) behavioral; 2) dataflow and/or 3) structural code. The system may generate any type of HDL code the user wants to generate, including: structural, behavioral or other code. The code generated may depends on what the LLM ingests during training.

A testbench may be generated for the code using the deep neural network, wherein features of the code and the module generation request may be input into the deep neural network to obtain the test bench code, as in block 530.

A functional simulation of the code may be executed using the testbench, as in block 540. The execution of a functional simulation may include executing a syntactically correct testbench against the code. Diagnostic information may be written to temporary files and the temporary files may be processed at the end of the simulation to create a list of issues identified within the code.

The module may be regenerated when the functional simulation fails, and the re-generation may use the deep neural network and the request as input to the deep neural network. There may be threshold for function simulation failure that is measured by a percentage of failed tests or a raw number of failed tests. The regeneration of the module may occur as many times as desired or a number of times set in a settings file.

The code and related HDL code may be sent in order to be presented in the GUI or to a user when the function simulation passes tests of the testbench, as in block 550. The code and HDL code may include sending the HDL module to a user interface of a development environment using an API (application programming interface) call.

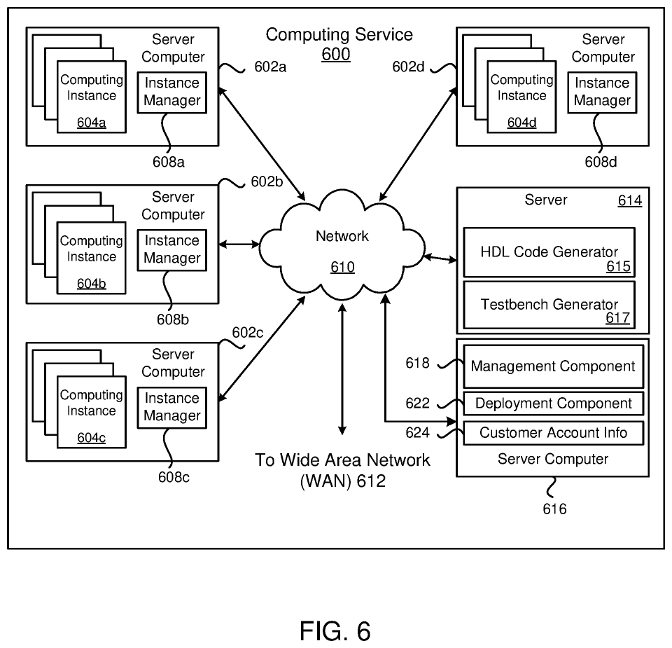

FIG. 6 is a block diagram illustrating an example computing service 600 that may be used to execute and manage a number of computing instances 604a-d upon which the present technology may execute. In particular, the computing service 600 depicted illustrates one environment in which the technology described herein may be used. The computing service 600 may be one type of environment that includes various virtualized service resources that may be used, for instance, to host computing instances 604a-d.

The computing service 600 may be capable of delivery of computing, storage and networking capacity as a software service to a community of end recipients. In one example, the computing service 600 may be established for an organization by or on behalf of the organization. That is, the computing service 600 may offer a “private cloud environment.” In another example, the computing service 600 may support a multi-tenant environment, wherein a plurality of customers may operate independently (i.e., a public cloud environment). Generally speaking, the computing service 600 may provide the following models: Infrastructure as a Service (“IaaS”) and/or Software as a Service (“SaaS”). Other models may be provided. For the IaaS model, the computing service 600 may offer computers as physical or virtual machines and other resources. The virtual machines may be run as guests by a hypervisor, as described further below. The PaaS model delivers a computing system that may include an operating system, programming language execution environment, database, and web server.

Application developers may develop and run their software solutions on the computing service system without incurring the cost of buying and managing the underlying hardware and software. The SaaS model allows installation and operation of application software in the computing service 600. End customers may access the computing service 600 using networked client devices, such as desktop computers, laptops, tablets, smartphones, etc. running web browsers or other lightweight client applications, for example. Those familiar with the art will recognize that the computing service 600 may be described as a “cloud” environment.

The particularly illustrated computing service 600 may include a plurality of server computers 602a-d. The server computers 602a-d may also be known as physical hosts. While four server computers are shown, any number may be used, and large data centers may include thousands of server computers. The computing service 600 may provide computing resources for executing computing instances 604a-d. Computing instances 604a-d may for example, be virtual machines. A virtual machine may be an instance of a software implementation of a machine (i.e. a computer) that executes applications like a physical machine. In the example of a virtual machine, each of the server computers 602a-d may be configured to execute an instance manager 608a-d capable of executing the instances. The instance manager 608a-d may be a hypervisor, virtual machine manager (VMM), or another type of program configured to enable the execution of multiple computing instances 604a-d on a single server. Additionally, each of the computing instances 604a-d may be configured to execute one or more applications.

A server may be reserved to execute software components for implementing the present technology or managing the operation of the computing service 600 and the computing instances 604a-d. For example, one server 614 may include an HDL code generator 615 and a test bench generator 617, for example, which are operating in the computing service 600.

A server computer 616 may execute a management component 618. A customer may access the management component 618 to configure various aspects of the operation of the computing instances 604a-d purchased by a customer. For example, the customer may setup computing instances 604a-d and make changes to the configuration of the computing instances 604a-d.

A deployment component 622 may be used to assist customers in the deployment of computing instances 604a-d. The deployment component 622 may have access to account information associated with the computing instances 604a-d, such as the name of an owner of the account, credit card information, country of the owner, etc. The deployment component 622 may receive a configuration from a customer that includes data describing how computing instances 604a-d may be configured. For example, the configuration may include an operating system, provide one or more applications to be installed in computing instances 604a-d, provide scripts and/or other types of code to be executed for configuring computing instances 604a-d, provide cache logic specifying how an application cache is to be prepared, and other types of information. The deployment component 622 may utilize the customer-provided configuration and cache logic to configure, prime, and launch computing instances 604a-d. The configuration, cache logic, and other information may be specified by a customer accessing the management component 618 or by providing this information directly to the deployment component 622.

Customer account information 624 may include any desired information associated with a customer of the multi-tenant environment. For example, the customer account information may include a unique identifier for a customer, a customer address, billing information, licensing information, customization parameters for launching instances, scheduling information, etc. As described above, the customer account information 624 may also include security information used in encryption of asynchronous responses to API requests. By “asynchronous” it is meant that the API response may be made at any time after the initial request and with a different network connection.

A network 610 may be utilized to interconnect the computing service 600 and the server computers 602a-d, 616. The network 610 may be a local area network (LAN) and may be connected to a Wide Area Network (WAN) 612 or the Internet, so that end customers may access the computing service 600. In addition, the network 610 may include a virtual network overlaid on the physical network to provide communications between the servers 602a-d. The network topology illustrated in FIG. 6 has been simplified, as many more networks and networking devices may be utilized to interconnect the various computing systems disclosed herein.

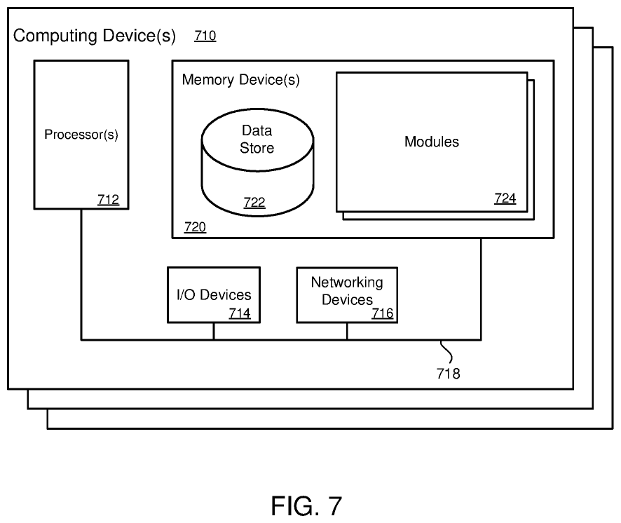

FIG. 7 illustrates a computing device 710 on which modules of this technology may execute. The computing device 710 is illustrated on which a high level example of the technology may be executed. The computing device 710 may include one or more processors 712 that are in communication with memory devices 720. The computing device may include a local communication interface 718 for the components in the computing device. For example, the local communication interface may be a local data bus and/or any related address or control busses as may be desired.

The memory device 720 may contain modules 724 that are executable by the processor(s) 712 and data for the modules 724. The modules 724 may execute the functions described earlier. A data store 722 may also be located in the memory device 720 for storing data related to the modules 724 and other applications along with an operating system that is executable by the processor 712 (or processors).

Other applications may also be stored in the memory device 720 and may be executable by the processor 712 (or processors). Components or modules discussed in this description that may be implemented in the form of software using high programming level languages that are compiled, interpreted or executed using a hybrid of the methods.

The computing device may also have access to I/O (input/output) devices 714 that are usable by the computing devices. An example of an I/O device is a display screen that is available to display output from the computing devices. Other known I/O device may be used with the computing device as desired. Networking devices 716 and similar communication devices may be included in the computing device. The networking devices 716 may be wired or wireless networking devices that connect to the internet, a LAN, WAN, or other computing network.

The components or modules that are shown as being stored in the memory device 720 may be executed by the processor 712. The term “executable” may mean a program file that is in a form that may be executed by a processor 712. For example, a program in a higher level language may be compiled into machine code in a format that may be loaded into a random access portion of the memory device 720 and executed by the processor 712, or source code may be loaded by another executable program and interpreted to generate instructions in a random access portion of the memory to be executed by a processor. The executable program may be stored in any portion or component of the memory device 720. For example, the memory device 720 may be random access memory (RAM), read only memory (ROM), flash memory, a solid state drive, memory card, a hard drive, optical disk, floppy disk, magnetic tape, or any other memory components.

The processor 712 may represent multiple processors and the memory 720 may represent multiple memory units that operate in parallel to the processing circuits. This may provide parallel processing channels for the processes and data in the system. The local interface 718 may be used as a network to facilitate communication between any of the multiple processors and multiple memories. The local interface 718 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for generating HDL code using machine learning, comprising:
receiving a request which includes a natural-language description for a high-level representation of computer hardware behavior;
generating code which includes HDL code for a module, using a deep neural network, wherein the request is used as input to the deep neural network;
generating a testbench for the code using the deep neural network, wherein features of the code and the module generation request are input into the deep neural network;
executing a functional simulation of the code using the testbench; and
sending the code to be presented when the function simulation passes tests of the testbench.

2. The method as in claim 1, further comprising re-generating the module when the functional simulation fails, wherein the re-generation uses the deep neural network and the request as input to the deep neural network.

3. The method as in claim 1, wherein sending the code and related HDL code further comprises sending the module to a user interface of a development environment using an API (application programming interface) call.

4. The method as in claim 1, wherein the features of the code include at least one of: a number of inputs, a number of outputs, functional keywords, hardware keywords, or memory keywords.

5. The method as in claim 1, wherein in the HDL codes are in Verilog or VHSIC Hardware Description Language (VHDL).

6. The method as in claim 1, wherein executing a functional simulation further comprises executing a syntactically correct testbench against the code.

7. The method as in claim 1, further comprising writing diagnostic information to temporary files that are processed at the end of the simulation to create a list of issues identified within the code.

8. The method as in claim 1, wherein the deep neural network is trained on a data set of synthesizable HDL code blocks.

9. The method as in claim 1, wherein the deep neural network is a language model.

10. The method as in claim 9, wherein the deep neural network neural network that is a transformer, encoder-decoder transformer, a text-to-text transformer or a generative adversarial network (GAN).

11. A system for generating functionally-correct HDL code using machine learning, comprising:
an event watchdog to receive a module generation request which includes a natural-language description for a high-level representation of computer hardware behavior;
an HDL code generator, which includes a deep neural network, configured to produce code which includes HDL code for a module, wherein the module generation request is used as input to the deep neural network;
a testbench, which includes the deep neural network, to generate code using the deep neural network, wherein features of the code and/or the module generation request are input into the deep neural network;
a functional simulator to simulate execution of the code using the testbench; and
a message dispatcher to send the code of the module to be presented when the function simulation passes.

12. The system as in claim 11, wherein the HLD code generator re-generates the module using the deep neural network and the module generation request as input, when the function simulation fails.

13. The system as in claim 11, wherein the functional simulator sends the code for the module to a front end of a development environment using an API (application programming interface) call, when the function simulation passes.

14. The system as in claim 13, wherein the deep neural network is trained on a data set of synthesizable HDL code blocks.

15. The system as in claim 13, wherein the deep neural network is a language model.

16. A machine-readable storage medium having instructions embodied thereon, the instructions when executed by one or more processors, cause the one or more processors to perform a process comprising:
receiving a module generation request which includes a natural-language description for a high-level representation of hardware behavior;
generating code which includes HDL code for a module, using a deep neural network, wherein the module generation request is used as input to the deep neural network;
generating a testbench for the code using the deep neural network, wherein features of the code and the module generation request are input into the deep neural network;
executing a functional simulation of the code using the testbench; and
sending code of the module to be presented when the function simulation passes.

17. The machine-readable storage medium as in claim 16, re-generating the module using the deep neural network and the module generation request as input, when the function simulation fails.

18. The machine-readable storage medium as in claim 16, wherein executing a functional simulation further comprises executing a syntactically correct testbench against the code.

19. The machine-readable storage medium as in claim 16, wherein the deep neural network is trained on a data set of synthesizable HDL code blocks.

20. The machine-readable storage medium as in claim 16, wherein the deep neural network is a language model.
